(19) United States
(12) Patent Application Publication
(10) Pub. No.: US 2026/0003853 A1
(43) Pub. Date: Jan. 1, 2026

(54) DATA CONFLICT RESOLUTION AND MANAGEMENT

(71) Applicant: Twilio Inc., San Francisco, CA (US)

(72) Inventors: Aaron Klish, San Francisco, CA (US); Jayakrishnan Nair, San Francisco, CA (US); Anand Ramakrishnan, San Francisco, CA (US); Atit Shah, San Francisco, CA (US); Emma Sims, San Francisco, CA (US)

(21) Appl. No.: 18/758,933

(22) Filed: Jun. 28, 2024

(51) Int. Cl. G06F 16/23

(52) U.S. Cl. CPC G06F 16/2365; G06F 16/2308

(57) ABSTRACT

Various embodiments described herein support or provide operations for facilitating the management and resolution of conflicting user data collected across multiple sources. Specifically, a conflict on a data attribute is identified. The conflict indicates that conflicting values were configured via a plurality of devices over a period of time. One or more conflict resolution policies configured for the data attribute are identified. A value of the data attribute is generated based on the one or more conflict resolution policies.

### TECHNICAL FIELD

The present disclosure generally relates to data management. More particularly, various embodiments described herein provide for systems, methods, techniques, instruction sequences, and devices that facilitate managing and resolving conflicting user data collected across multiple sources.

### BACKGROUND

In the realm of digital technology, particularly within systems that operate across various platforms such as desktops, mobile devices, and tablets, there is a continuous collection of user data. This data is often utilized to construct comprehensive user profiles, which are integral to enhancing user experience and personalizing services. However, the process of collecting data from multiple sources frequently leads to discrepancies and conflicts in the information gathered. These discrepancies and conflicts can arise when the same user interacts with the system through different devices or at different times, often leading to variations in the data collected. Managing these variations poses a challenge as it impacts the accuracy and reliability of the user profiles generated.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system, according to various embodiments of the present disclosure.

FIG. 2 is a block diagram illustrating an example data management system that facilitates managing and resolving conflicting user data collected across multiple sources, according to various embodiments of the present disclosure.

FIG. 3 is a flowchart illustrating an example method for facilitating the management and resolution of conflicting user data collected across multiple sources, according to various embodiments of the present disclosure.

FIG. 4 is a flowchart illustrating an example method for facilitating the management and resolution of conflicting user data collected across multiple sources, according to various embodiments of the present disclosure.

FIG. 5 is a block diagram illustrating a representative software architecture, which may be used in conjunction with various hardware architectures herein described, according to various embodiments of the present disclosure.

FIG. 6 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Various embodiments include systems, methods, and non-transitory computer-readable media that facilitate managing and resolving conflicting user data collected across multiple sources, according to various embodiments of the present disclosure. In today's digital age, the ability to collect and manage user data effectively across multiple sources (e.g., platforms and devices) is crucial for businesses. This data gathered from various devices, such as laptops, desktops, mobile phones, and tablets, is used to build detailed user profiles. These profiles are instrumental in enhancing user experiences by providing personalized content, recommendations, and services. However, the process of collecting data from multiple sources often results in discrepancies and conflicts in the data, which can complicate the creation of a unified user profile.

Various embodiments discuss strategies for managing conflicts in user data collected and/or merged from multiple sources over time. Customers can configure conflict resolution strategies (also referred to as conflict resolution policies) based on factors such as business needs, specific requirements (e.g., regulatory requirements, risk management requirements), and continuous improvement.

Business needs: Customers can analyze their business processes and identify critical data attributes where conflicts may occur. They then determine the desired outcomes or behaviors for resolving conflicts in these attributes based on their business objectives.

Regulatory requirements: Customers can consider regulatory requirements and industry standards that govern data management and privacy. They can configure conflict resolution policies to ensure compliance with relevant regulations, such as the General Data Protection Regulation (GDPR), the Health Insurance Portability and Accountability Act (HIPAA), industry-specific data protection laws, etc.

Risk management requirements: Customers can assess the potential risks associated with conflicting data and prioritize resolution strategies accordingly. They can prioritize data accuracy, consistency, or security based on the sensitivity and impact of the data attributes involved.

Continuous improvement: Customers can regularly review and refine their conflict resolution policies based on feedback, data analysis, and evolving business requirements. They can optimize the policies and enhance the effectiveness of conflict resolution processes over time.

Customizing conflict resolution policies allows businesses to align conflict resolution with their priorities, operational workflows, and compliance standards.

Conflict resolution policies address two main types of conflicts, i.e., device-level conflicts and profile-level conflicts.

Device-level conflicts occur when the same user provides different data on separate platforms. For instance, a user may log into a system using a desktop computer and provide an email address. Later, the same user may use a mobile device to log into the same system but provide a different email address. These conflicting data can lead to confusion and inaccuracies in the user profile.

Profile-level conflicts, on the other hand, arise when distinct user profiles need to be merged. User profiles can be created during different sessions or under different user identifiers. This situation is common when a user has used multiple devices or has not consistently identified themselves across sessions. When profiles are merged, conflicting data entries need to be reconciled to create a single, comprehensive user profile.

In various embodiments, policies that address profile-level conflicts include, without limitation, a merging-in-lists policy, a latest-win policy, a preserving-first-occurrence policy, a preferring-true policy, a leave-in-conflict policy, and a preferring-identified-user-over-anonymous-user policy. Policies that address device-level conflicts include, without limitation, a merging-in-lists policy, a latest-win policy, a preserving-first-occurrence policy, a user-resolving-conflict policy, a preferring-false policy, a leave-in-conflict policy, and a business-logic-based policy.

Merging-in-lists policy: This policy allows conflicting data attributes to be combined to form a list of values. For example, if two different phone numbers are associated with the same user profile, both numbers are retained in the user profile as a list. This method preserves all values, allowing for a comprehensive aggregation of data.

Latest-win policy: This policy allows the most recently provided data value to override any previous entries. For example, if a profile has two different phone numbers collected over a period of time. The most recent phone number overrides the previous phone number. It is based on the assumption that the most recent data is likely the most accurate and/or relevant.

Preserving-first-occurrence policy: Contrary to the latest-win policy, this policy prioritizes a user's first-provided data entry, disregarding any subsequent conflicting data entries. It can be used in scenarios where initial data is considered more reliable.

Preferring-True policy (Liberal policy): This policy prioritizes the value “true” over other conflicting values provided for the same data attribute. It can be applied when affirming a condition or preference is deemed more critical.

Leave-in-conflict policy: This policy allows conflicting data to co-exist in a profile. The user profile will have the data value set as “conflict” for that data attribute. Subsequently, it becomes the responsibility of the system utilizing the profile to decide its usage. For instance, if a user's advertising consent preference is true in one profile and false in another, merging these preferences would result in setting the advertising consent preference to “conflict.” Based on the system's requirements and workflow, it can interpret “conflict” as either true or false.”

Preferring-identified-user-over-anonymous-user policy: When conflicting values of a data attribute arise from profile merging, such as when combining an identified profile with an anonymous one, this policy resolves the conflict by prioritizing the value configured by the identified profile associated with an identified user identifier.

User-resolving-conflict policy: This policy empowers the user to directly address and resolve any discrepancies in their data. The system may prompt users to review the conflicting data and select or verify the correct entries.

Preferring-false policy (Conservative policy): This policy prioritizes the value “false” over other conflicting values (e.g., “true” or “conflict”) provided for the same data attribute. For instance, when conflicting data values arise regarding a user's consent for receiving marketing emails, where one preference indicates consent (with the value set to “true”) and another indicates denial (also with the value set to “false”), the policy resolves the conflict by setting the preference to “false.”

Business-logic-based policy: Different policies may be implemented based on one or more data attributes in a given user profile. For instance, if a user's profile indicates they are from California, a “preferring-false policy” is applied. Conversely, users from other states are subjected to alternative policies. These policies can range from simple determinations based on a single data attribute (e.g., location) to more complex evaluations involving multiple data attributes.

These conflict resolution policies are integral to the system's ability to create accurate and reliable user profiles from fragmented and conflicting data sources. By implementing these conflict management techniques, the generated user profiles can be comprehensive and reflective of the most accurate data available, thereby enhancing the overall user experience and the effectiveness of personalized services.

In various embodiments, a data management system identifies a device-level conflict on a data attribute (e.g., a user's name, email address, phone number, interests, consent preference on the use of personal data, email address) associated with a user identifier. A device-level conflict indicates that conflicting values were configured (or provided) via a plurality of devices associated with the user identifier over a period of time. A user identifier can correspond to a unique identifier assigned to a user profile that is created to include a plurality of data attributes associated with a specific user. The data management system identifies a plurality of device-level conflict resolution policies configured for the data attribute. The data management system generates a value of the data attribute by applying one of the device-level conflict resolution policies to the device-level conflict. The plurality of device-level conflict resolution policies can be arranged in a prioritized list where each of the plurality of device-level conflict resolution policies is assigned a priority level representing the importance of the policy. The data management system can identify one of the policies (e.g., a policy with the highest priority level) for application.

In various embodiments, the data management system identifies a profile-level conflict on the data attribute associated with the user identifier. A profile-level conflict may arise when there are conflicting values for a data attribute due to the merging of multiple profiles. The data management system identifies a profile-level conflict resolution policy configured for the data attribute. The data management system generates the value of the data attribute by applying the profile-level conflict resolution policy to the profile-level conflict. In various embodiments, the device-level conflict resolution policy can be applied before applying the profile-level conflict resolution policy. In various embodiments, the profile-level conflict resolution policy can be applied before applying the device-level conflict resolution policy.

A customer can configure one or more conflict resolution policies for a given data attribute based on business needs and/or specific requirements (e.g., regulatory requirements, risk management requirements) described herein. This customization allows businesses to tailor conflict resolution to align with their priorities, operational workflows, and compliance standards.

In various embodiments, a value of a data attribute can represent either true, false, or conflict. For example, a value of a data attribute can indicate a user's consent preference is provided at a specific timestamp (e.g., 2 pm on Mar. 10, 2024) within a defined time period (e.g., 30 days).

In various embodiments, a data attribute can correspond to an element of a user associated with the user identifier or an element of an application associated with the user identifier. A data value of the data attribute can correspond to one or more input values of the element of the user or the element of the application at a timestamp within a defined period of time.

In various embodiments, the data management system identifies a plurality of conflict resolution policies (e.g., device-level conflict resolution policies, profile-level conflict resolution policies) configured for a data attribute. Each conflict resolution policy is assigned a priority level, indicating an order in which the plurality of conflict resolution policies is applied. The data management system generates a value of the data attribute based on the priority levels assigned to conflict resolution policies.

Reference will now be made in detail to embodiments of the present disclosure, examples of which are illustrated in the appended drawings. The present disclosure may, however, be embodied in many different forms and should not be construed as being limited to the embodiments set forth herein.

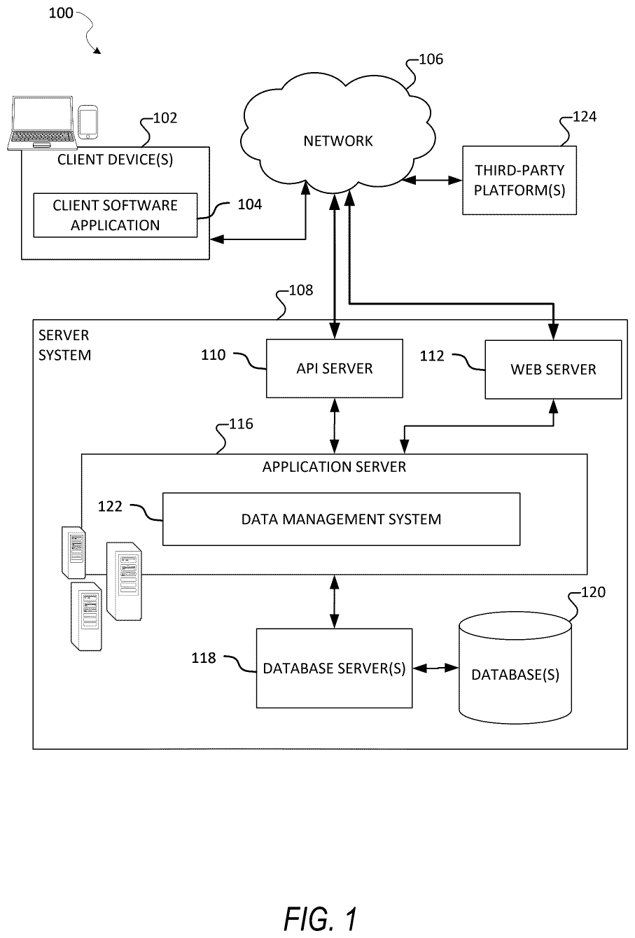

FIG. 1 is a block diagram showing an example data system 100 that includes a data management system 122 (also referred to as system 122), according to various embodiments of the present disclosure. By including the data management system 122, the data system 100 can facilitate machine learning model training using the LCA and the LSTA approaches. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 at the data management system 122, and the data management system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the data management system 122 may extract user data from one or more third-party platforms (e.g., third-party social media platforms). The extracted data may be open-source poster data associated with targeted influencers on the one or more third-party platforms 124 and may include user profile data, activity data, and media posted (either created and/or shared) by the one or more influencers. The media (or media data) include text, image, video, audio, and metadata. Example metadata may include hashtags and labels.

Through one or more web-based interfaces (e.g., web-based user interfaces), the web server 112 can support various functionality of the data management system 122 of the application server 116.

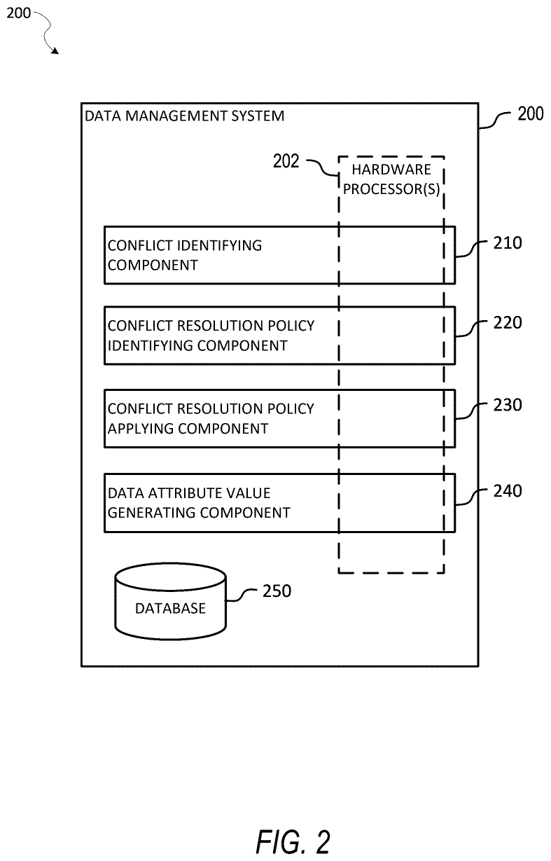

FIG. 2 is a block diagram illustrating an example data management system 200 that facilitates managing and resolving conflicting user data collected across multiple sources, according to various embodiments of the present disclosure. For some embodiments, the data management system 200 represents an example of the data management system 122 described with respect to FIG. 1. As shown, the data management system 200 comprises a conflict identifying component 210, a conflict resolution policy identifying component 220, a conflict resolution policy applying component 230, and a data attribute value generating component 240. According to various embodiments, one or more of the conflict identifying component 210, the conflict resolution policy identifying component 220, the conflict resolution policy applying component 230, and the data attribute value generating component 240 are implemented by one or more hardware processors 202. Data generated by one or more of the conflict identifying component 210, the conflict resolution policy identifying component 220, the conflict resolution policy applying component 230, and the data attribute value generating component 240 may be stored in a database (or datastore) 250 of the data management system 200.

The conflict identifying component 210 is configured to identify a conflict (e.g., device-level conflicts, profile-level conflicts) on data attributes. Data attributes can include a user's name, email address, phone number, interests, consent preference on the use of personal data, email address, etc. A device-level conflict indicates that conflicting values were configured (or provided) via a plurality of devices associated with the user identifier over a period of time. A profile-level conflict may arise when there are conflicting values for a data attribute due to the merging of multiple profiles. A user identifier can correspond to a unique identifier assigned to a user profile created to include a plurality of data attributes associated with a specific user.

The conflict resolution policy identifying component 220 is configured to identify a plurality of conflict resolution policies (e.g., device-level conflict resolution policies, profile-level conflict resolution policies) configured for a specific data attribute described herein.

The conflict resolution policy applying component 230 is configured to apply one or more conflict resolution policies to the identified conflicts.

The data attribute value generating component 240 is configured to generate a value for a data attribute (e.g., a data attribute with conflicting data values) based on (or in response to) the applying of the one or more conflict resolution policies to the identified conflicts.

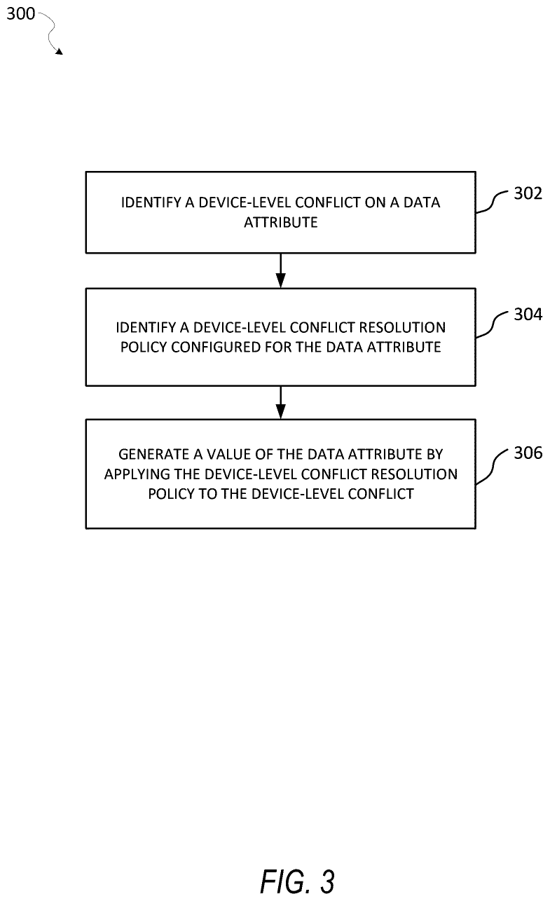

FIG. 3 is a flowchart illustrating an example method 300 for facilitating the management and resolution of conflicting user data collected across multiple sources, according to various embodiments of the present disclosure. It will be understood that example methods described herein may be performed by a machine in accordance with some embodiments. For example, method 300 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor system identifies a device-level conflict on a data attribute. Data attributes can include a user's name, email address, phone number, interests, consent preference on the use of personal data, email address, etc. A device-level conflict indicates that conflicting values were configured (or provided) via a plurality of devices associated with the user identifier over a period of time. A user identifier can correspond to a unique identifier assigned to a user profile created to include a plurality of data attributes associated with a specific user.

At operation 304, a processor identifies a plurality of device-level conflict resolution policies configured for the data attribute. The policies can be arranged in a prioritized list, with each policy assigned a priority level representing its importance. A processor can identify one of the policies (e.g., a policy with the highest priority level) for application.

At operation 306, a processor generates a value of the data attribute by applying one of the device-level conflict resolution policies to the device-level conflict.

Though not illustrated, method 300 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 306 or, alternatively, form part of one or more of operations 302 through 306.

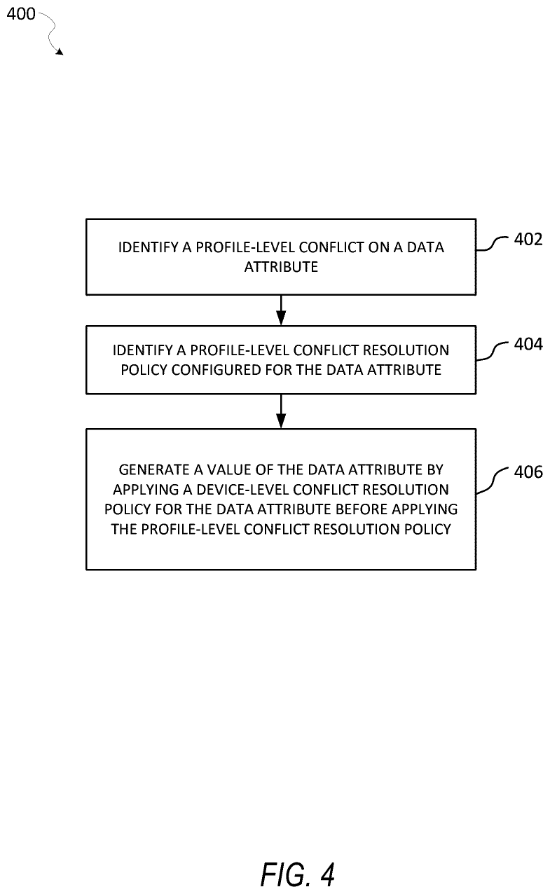

FIG. 4 is a flowchart illustrating an example method 400 for facilitating the management and resolution of conflicting user data collected across multiple sources, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 400 can be performed dependently or independently from operations in method 300.

At operation 402, a processor identifies a profile-level conflict on a data attribute associated with the user identifier. A data attribute can be associated with a device-level conflict, a profile-level conflict, or both. A profile-level conflict may arise when there are conflicting values for a data attribute due to the merging of multiple profiles.

At operation 404, a processor identifies a plurality of profile-level conflict resolution policies configured for the data attribute. The plurality of profile-level conflict resolution policies can be arranged in a prioritized list, with each policy assigned a priority level representing its importance. A processor can identify one of the policies based on the associated priority level (e.g., the highest priority level) for resolving the conflict.

At operation 406, a processor generates a value of the data attribute by applying the profile-level conflict resolution policy to the profile-level conflict. In various embodiments, when both a device-level conflict and a profile-level conflict are identified for a data attribute, a device-level conflict resolution policy is applied before applying a profile-level conflict resolution policy.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 406 or, alternatively, form part of one or more of operations 402 through 406.

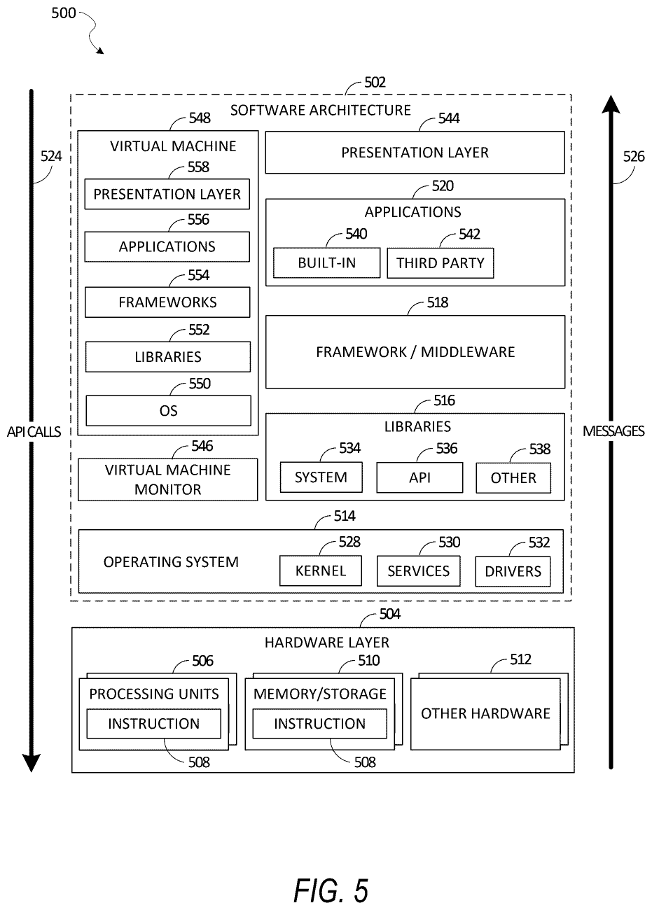

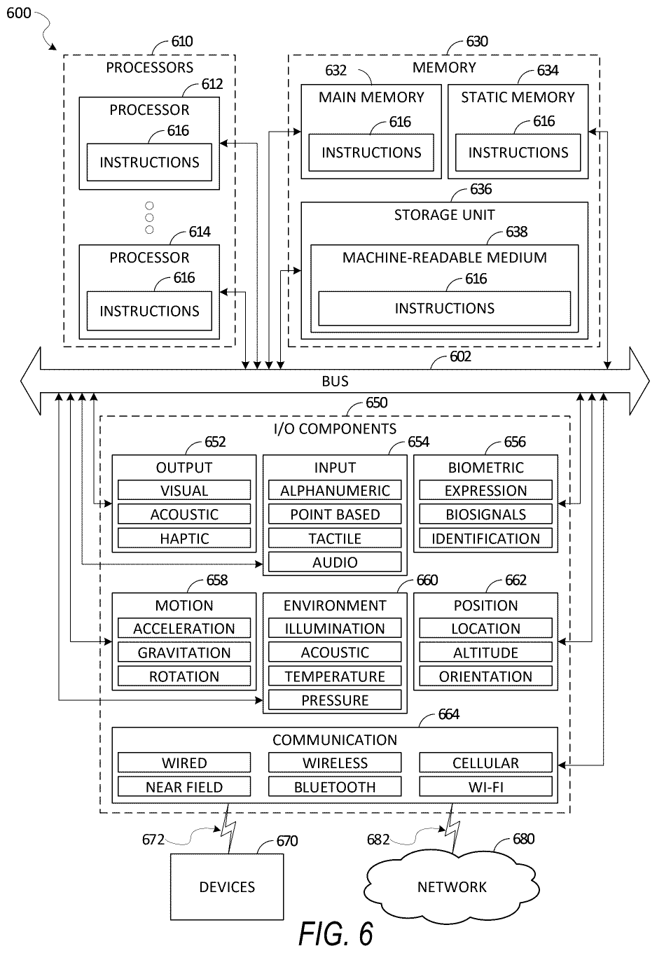

FIG. 5 is a block diagram illustrating an example of a software architecture 502 that may be installed on a machine, according to some example embodiments. FIG. 5 is merely a non-limiting example of a software architecture, and it will be appreciated that many other architectures may be implemented to facilitate the functionality described herein. The software architecture 502 may be executing on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 comprises one or more processing units 506 having associated executable instructions 508. The executable instructions 508 represent the executable instructions of the software architecture 502. The hardware layer 504 also includes memory or storage modules 510, which also have the executable instructions 508. The hardware layer 504 may also comprise other hardware 512, which represents any other hardware of the hardware layer 504, such as the other hardware illustrated as part of the machine 1200.

In the example architecture of FIG. 5, the software architecture 502 may be conceptualized as a stack of layers, where each layer provides particular functionality. For example, the software architecture 502 may include layers such as an operating system 514, libraries 516, frameworks/middleware 518, applications 520, and a presentation layer 544. Operationally, the applications 520 or other components within the layers may invoke API calls 524 through the software stack and receive a response, returned values, and so forth (illustrated as messages 526) in response to the API calls 524. The layers illustrated are representative in nature, and not all software architectures have all layers. For example, some mobile or special-purpose operating systems may not provide a frameworks/middleware 518 layer, while others may provide such a layer. Other software architectures may include additional or different layers.

The operating system 514 may manage hardware resources and provide common services. The operating system 514 may include, for example, a kernel 528, services 530, and drivers 532. The kernel 528 may act as an abstraction layer between the hardware and the other software layers. For example, the kernel 528 may be responsible for memory management, processor management (e.g., scheduling), component management, networking, security settings, and so on. The services 530 may provide other common services for the other software layers. The drivers 532 may be responsible for controlling or interfacing with the underlying hardware. For instance, the drivers 532 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 516 may provide a common infrastructure that may be utilized by the applications 520 and/or other components and/or layers. The libraries 516 typically provide functionality that allows other software modules to perform tasks in an easier fashion than by interfacing directly with the underlying operating system 514 functionality (e.g., kernel 528, services 530, or drivers 532). The libraries 516 may include system libraries 534 (e.g., C standard library) that may provide functions such as memory allocation functions, string manipulation functions, mathematic functions, and the like. In addition, the libraries 516 may include API libraries 536 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 516 may also include a wide variety of other libraries 538 to provide many other APIs to the applications 520 and other software components/modules.

The frameworks 518 (also sometimes referred to as middleware) may provide a higher-level common infrastructure that may be utilized by the applications 520 or other software components/modules. For example, the frameworks 518 may provide various graphical user interface functions, high-level resource management, high-level location services, and so forth. The frameworks 518 may provide a broad spectrum of other APIs that may be utilized by the applications 520 and/or other software components/modules, some of which may be specific to a particular operating system or platform.

The applications 520 include built-in applications 540 and/or third-party applications 542. Examples of representative built-in applications 540 may include, but are not limited to, a home application, a contacts application, a browser application, a book reader application, a location application, a media application, a messaging application, or a game application.

The third-party applications 542 may include any of the built-in applications 540, as well as a broad assortment of other applications. In a specific example, the third-party applications 542 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 542 may invoke the API calls 524 provided by the mobile operating system such as the operating system 514 to facilitate functionality described herein.

The applications 520 may utilize built-in operating system functions (e.g., kernel 528, services 530, or drivers 532), libraries (e.g., system libraries 534, API libraries 536, and other libraries 538), or frameworks/middleware 518 to create user interfaces to interact with users of the system. Alternatively, or additionally, in some systems, interactions with a user may occur through a presentation layer, such as the presentation layer 544. In these systems, the application/module “logic” can be separated from the aspects of the application/module that interact with the user.

Some software architectures utilize virtual machines. In the example of FIG. 5, this is illustrated by a virtual machine 548. The virtual machine 548 creates a software environment where applications/modules can execute as if they were executing on a hardware machine (e.g., the machine 600 of FIG. 6). The virtual machine 548 is hosted by a host operating system (e.g., the operating system 514) and typically, although not always, has a virtual machine monitor 546, which manages the operation of the virtual machine 548 as well as the interface with the host operating system (e.g., the operating system 514). A software architecture executes within the virtual machine 548, such as an operating system 550, libraries 552, frameworks 554, applications 556, or a presentation layer 558. These layers of software architecture executing within the virtual machine 548 can be the same as corresponding layers previously described or may be different.

FIG. 6 illustrates a diagrammatic representation of a machine 600 in the form of a computer system within which a set of instructions may be executed for causing the machine 600 to perform any one or more of the methodologies discussed herein, according to an embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 to execute the method 300 described above with respect to FIG. 3, and the method 400 described above with respect to FIG. 4. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an embodiment, the processors 610 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory 630 may include a main memory 632, a static memory 634, and a storage unit 636 including machine-readable medium 638, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion, and the grouping is in no way limiting. In some examples, the I/O components 650 may include output components 652 and input components 654. The output components 652 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 650 may include biometric components 656, motion components 658, environmental components 660, or position components 662, among a wide array of other components. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 600 including processors 610), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 600, but deployed across a number of machines 600. In some example embodiments, the processors 610 or processor-implemented modules are located in a single geographic location (e.g., within a home environment, an office environment, or a server farm). In other example embodiments, the processors or processor-implemented modules are distributed across a number of geographic locations.

The various memories (i.e., 630, 632, 634, and/or the memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 616 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In some examples, one or more portions of the network 680 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
identifying a device-level conflict on a data attribute associated with a user identifier, the device-level conflict indicating that conflicting values were configured via a plurality of devices associated with the user identifier over a period of time;
identifying a device-level conflict resolution policy configured for the data attribute; and
generating a value of the data attribute, the generating of the value including applying the device-level conflict resolution policy to the device-level conflict.

2. The method of claim 1, comprising:
identifying a profile-level conflict on the data attribute associated with the user identifier, the profile-level conflict indicating that conflicting values of the data attribute resulting from merging of a plurality of profiles;
identifying a profile-level conflict resolution policy configured for the data attribute; and
generating the value of the data attribute, the generating of the value including applying the device-level conflict resolution policy before applying the profile-level conflict resolution policy.

3. The method of claim 2, wherein the profile-level conflict resolution policy comprises one or more of a merging-in-lists policy, a latest-win policy, a preserving-first-occurrence policy, a preferring-true policy, a preferring-false policy, a leave-in-conflict policy, and a preferring-identified-user-over-anonymous-user policy.

4. The method of claim 3, wherein the merging-in-lists policy comprises a policy that resolves conflicting values of the data attribute by merging conflicting values of the data attribute to form a list of attribute values, wherein the preserving-first-occurrence policy comprises a policy that resolves conflicting values of the data attribute based on a first-provided data value made available by the user identifier, wherein the preferring-true policy comprises a policy that resolves conflicting values of the data attribute by assigning a data value of true to the data attribute, wherein the leave-in-conflict policy comprises a policy that resolves conflicting values of the data attribute by allowing conflicting values of the data attribute to co-exist in a profile associated with the user identifier, and the preferring-identified-user-over-anonymous-user policy comprises a policy that resolves conflicting values of the data attribute based on a value of the data attribute configured via an identified user identifier.

5. The method of claim 1, wherein the value of the data attribute comprises a value representing true, false, or conflict.

6. The method of claim 1, wherein the device-level conflict resolution policy comprises one or more of a merging-in-lists policy, a latest-win policy, a preserving-first-occurrence policy, a user-resolving-conflict policy, a preferring-true policy, a preferring-false policy, and a leave-in-conflict policy.

7. The method of claim 6, wherein the merging-in-lists policy comprises a policy that merges conflicting values of the data attribute to form a list of attribute values, wherein the latest-win policy comprises a policy that resolves conflicting values of the data attribute based on a recent data value made available by the user identifier, wherein the preserving-first-occurrence policy comprises a policy that resolves conflicting values of the data attribute based on a first-provided data value made available by the user identifier, wherein the user-resolving-conflict policy comprises a policy that resolves conflicting values of the data attribute by allowing the user identifier to provide an appropriate data value for the data attribute, wherein the preferring-false policy comprises a policy that resolves conflicting values of the data attribute by assigning a data value of false to the data attribute, and wherein the leave-in-conflict policy comprises a policy that allows conflicting values of the data attribute to co-exist in a profile associated with the user identifier.

8. The method of claim 1, wherein a data value of the data attribute corresponds to a consent preference specified by the user identifier at a timestamp in the period of time.

9. The method of claim 1, wherein the data attribute corresponds to an element of a user associated with the user identifier or an application associated with the user identifier, and wherein a data value of the data attribute corresponds to one or more input values of the element of the user or the application at a timestamp in the period of time.

10. The method of claim 1, comprising:
identifying a plurality of device-level conflict resolution policies configured for the data attribute, each device-level conflict resolution policy being assigned a priority level indicating an order in which plurality of device-level conflict resolution policies is applied; and
generating the value of the data attribute based on the priority level assigned to each device-level conflict resolution policy.

11. A system comprising:
one or more hardware processors; and
at least one machine-storage medium for storing instructions that, when executed by the one or more hardware processors, cause the one or more hardware processors to perform operations comprising:
identifying a device-level conflict on a data attribute associated with a user identifier, the device-level conflict indicating that conflicting values were configured via a plurality of devices associated with the user identifier over a period of time;
identifying a device-level conflict resolution policy configured for the data attribute; and
generating a value of the data attribute, the generating of the value including applying the device-level conflict resolution policy to the device-level conflict.

12. The system of claim 11, wherein the operations comprise:
identifying a profile-level conflict on the data attribute associated with the user identifier, the profile-level conflict indicating that conflicting values of the data attribute resulting from merging of a plurality of profiles;
identifying a profile-level conflict resolution policy configured for the data attribute; and
generating the value of the data attribute, the generating of the value including applying the device-level conflict resolution policy before applying the profile-level conflict resolution policy.

13. The system of claim 12, wherein the profile-level conflict resolution policy comprises one or more of a merging-in-lists policy, a latest-win policy, a preserving-first-occurrence policy, a preferring-true policy, a preferring-false policy, a leave-in-conflict policy, and a preferring-identified-user-over-anonymous-user policy.

14. The system of claim 13, wherein the merging-in-lists policy comprises a policy that resolves conflicting values of the data attribute by merging conflicting values of the data attribute to form a list of attribute values, wherein the preserving-first-occurrence policy comprises a policy that resolves conflicting values of the data attribute based on a first-provided data value made available by the user identifier, wherein the preferring-true policy comprises a policy that resolves conflicting values of the data attribute by assigning a data value of true to the data attribute, wherein the leave-in-conflict policy comprises a policy that resolves conflicting values of the data attribute by allowing conflicting values of the data attribute to co-exist in a profile associated with the user identifier, and the preferring-identified-user-over-anonymous-user policy comprises a policy that resolves conflicting values of the data attribute based on a value of the data attribute configured via an identified user identifier.

15. The system of claim 11, wherein the value of the data attribute comprises a value representing true, false, or conflict.

16. The system of claim 11, wherein the device-level conflict resolution policy comprises one or more of a merging-in-lists policy, a latest-win policy, a preserving-first-occurrence policy, a user-resolving-conflict policy, a preferring-true policy, a preferring-false policy, and a leave-in-conflict policy.

17. The system of claim 16, wherein the merging-in-lists policy comprises a policy that merges conflicting values of the data attribute to form a list of attribute values, wherein the latest-win policy comprises a policy that resolves conflicting values of the data attribute based on a recent data value made available by the user identifier, wherein the preserving-first-occurrence policy comprises a policy that resolves conflicting values of the data attribute based on a first-provided data value made available by the user identifier, wherein the user-resolving-conflict policy comprises a policy that resolves conflicting values of the data attribute by allowing the user identifier to provide an appropriate data value for the data attribute, wherein the preferring-false policy comprises a policy that resolves conflicting values of the data attribute by assigning a data value of false to the data attribute, and wherein the leave-in-conflict policy comprises a policy that allows conflicting values of the data attribute to co-exist in a profile associated with the user identifier.

18. The system of claim 11, wherein the data attribute corresponds to an element of a user associated with the user identifier or an application associated with the user identifier, and wherein a data value of the data attribute corresponds to one or more input values of the element of the user or the application at a timestamp in the period of time.

19. The system of claim 11, wherein the operations comprise:
identifying a plurality of device-level conflict resolution policies configured for the data attribute, each device-level conflict resolution policy being assigned a priority level indicating an order in which plurality of device-level conflict resolution policies is applied; and
generating the value of the data attribute based on the priority level assigned to each device-level conflict resolution policy.

20. A machine-storage medium for storing instructions that, when executed by one or more hardware processors, cause the one or more hardware processors to perform operations comprising:
identifying a device-level conflict on a data attribute associated with a user identifier, the device-level conflict indicating that conflicting values were configured via a plurality of devices associated with the user identifier over a period of time;
identifying a device-level conflict resolution policy configured for the data attribute; and
generating a value of the data attribute, the generating of the value including applying the device-level conflict resolution policy to the device-level conflict.
